(19) United States
(12) Patent Application Publication
(10) Pub. No.: US 2014/0113031 A1
(43) Pub. Date: Apr. 24, 2014

(54) Nutritional Shake

(71) Applicant: Taylor D. Lee, Paramus, NJ (US)

(72) Inventor: Taylor D. Lee, Paramus, NJ (US)

(21) Appl. No.: 13/658,913

(22) Filed: Oct. 24, 2012

(51) Int. Cl. A23L 1/30; A23L 1/302; A23L 1/304; A23L 1/305

(52) U.S. Cl. 426/72; 426/583; 426/640

(57) ABSTRACT

A nutritional powder composition is disclosed. The nutritional powder composition comprises whey protein isolate, milled chia, hemp protein, wheat grass powder, and goji powder.

### BACKGROUND

1. Field

This disclosure relates generally to a composition of edible material, and, more particularly, to an edible composition containing an antioxidant.

2. Background

Proper nutrition is vital in maintaining health and wellness. Despite the importance of proper nutrition, the appropriate selection and apportionment of food is often ignored by consumers. The desire for convenience and the widespread ignorance of proper nutrition cause many to make poor nutritional choices, leading to the prevalence of many health conditions and diseases, such as obesity, diabetes and heart disease.

### BRIEF SUMMARY

In one aspect of this disclosure, a nutritional powder composition is disclosed. The nutritional powder composition comprises whey protein isolate, milled chia, hemp protein, wheat grass powder, and goji powder.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### DETAILED DESCRIPTION

This application discloses a nutritional powder composition for consumption. The powder may be consumed raw or (preferably) mixed with other edible elements for taste and texture. For example, the powder may be combined with water and a variety of selected fruits for better palatability. The nutritional powder composition may be used as a meal replacement or a supplement to normal eating.

The nutritional powder composition preferably contains at least five main ingredients. These five ingredients are whey protein isolate, milled chia, hemp protein, wheat grass powder, and goji powder. These ingredients compliment each other in terms of flavoring, when combined in the appropriate quantities. This makes the nutritional powder composition more palatable, and therefore easier to intake.

Whey protein isolate is an extremely high quality protein that is easily utilizable by the human body. It contains crucial amino acids for cellular growth and repair, and aids in glutathione production. It is usually produced from milk, being specially filtered to remove fat and lactose, and then dried without heat to avoid denaturing of the proteins. The resulting powder is very high in whey protein fractions, such as lactoferrin, glyco macro peptides and immunoglobulin. Beneficially, it lacks strong flavor (making it ideal for inclusion in a powder mix), and is digested easily without any ill effects to digestive health.

Milled chia is produced from the chia seed. These seeds contain high nutritional value, being potent in Omega-3 fatty acids, antioxidants, vitamins, minerals, soluble fiber, calcium, phosphorous, magnesium, manganese, copper, niacin, zinc and Omega-6 fatty acids (in a proper ratio relative to the Omega-3 fatty acids). With respect to antioxidants, chia seeds contain both primary and synergistic antioxidants, such as kaempferol flavonols, quercetin, myricetin, caffeic acid and chlorogenic acid. More pertinently, chia regulates the speed with which the human body converts carbohydrates into sugars. This helps stabilize the processing of food and other metabolic changes, diminishes energy highs and lows, maintaining a stable energy level through the day. Chia can also hold twelve times its weight in water, therefore aiding in hydration, as well as making the powder composition mix more palatable.

Wheatgrass aids in detoxification of the body. It contains necessary enzymes and antioxidants that aid in protecting the human body from free radicals and other similar carcinogens. Wheatgrass is also contains protein, all eight essential amino acids, a large number of nonessential amino acids, vitamins and chlorophyll. It also contains the anti-inflammatory superoxide dismutase, the reparatory P4D1 enzyme, and glycosaminoglycans, which are an important component of the synovial fluid used to lubricate bodily joints, as well as the chondroitins used in various connective tissues, such as tendons and cartilage.

Goji is a type of berry that includes extremely high levels of antioxidants, vitamins and minerals. It also contains phytonutrients and polysaccharides, and a high concentration of antioxidants. Goji contains eighteen amino acids, including the eight essential amino acids, a variety of vitamins, a plurality of trace minerals, besides being excellent source of basic protein.

These five ingredients may be combined in any quantity or ratio desired. However, the following table sets forth the example weight percentage of the main ingredients for a first exemplary formulation of the nutritional powder composition.

| Ingredients | Weight % (appx.) |
|---|---|
| Whey Protein Isolate | 15-40 |
| Milled Chia | 10-20 |
| Hemp Protein | 1-10 |
| Wheat Grass Powder | 1-10 |
| Goji Powder | 1-10 |

The following table sets forth the example weight percentage of the main ingredients for an exemplary formulation of a second nutritional powder composition.

| Ingredients | Weight % (appx.) |
|---|---|
| Whey Protein Isolate | 23-29 |
| Milled Chia | 10-16 |
| Hemp Protein | 3-9 |
| Wheat Grass Powder | 1-5 |
| Goji Powder | 1-5 |

The following table sets forth preferred weight percentages of the main ingredients for a preferred formulation of the nutritional powder composition.

| Ingredients | Weight % (appx.) |
|---|---|
| Whey Protein Isolate | 26.9 |
| Milled Chia | 6.7 |
| Hemp Protein | 6.7 |
| Wheat Grass Powder | 3.3 |
| Goji Powder | 3.3 |

A number of secondary ingredients may be added to the five main ingredients in order to provide additional health benefits. Secondary ingredients can be chosen from any possible beneficial food source. For example, secondary ingredients may be chosen from the categories of additional protein sources, additional fiber sources, additional energy sources, additional antioxidant sources, additional vitamin sources or additional superfoods. Any type of any number of additional ingredients may be added as desired. A number of exemplary secondary components are enumerated below.

Pea protein is a vegetable-based protein derived from the yellow pea or split pea. It is highly hypoallergenic, and contains a variety of beneficial compounds, such as the amino acid arginine, which may aid the body in building muscle mass, regulating metabolism, and healing damaged tissues.

Flax seed contains Omega-3 essential fatty acids, lignans and fiber. The Omega-3 fatty acids help fight free radicals and inhibit tumor incidence and growth. The lignans also may provide protection against cancers that are sensitive to hormones by blocking enzymes involved in hormone metabolism, thereby interfering with the growth of tumor cells. They also help regulate the body's anti-inflammatory response, and help reduce plaque build up within blood vessels.

Maca root contains calcium, fatty acids, vitamins B1, B2, B12, phosphorous, a variety of minerals and alkaloid. In practice, it boosts energy, endurance and performance, and aids the body in dealing with stress, and benefiting the endocrine system.

Cacao powder is a special powder made from the cacao seed, retaining a fair percentage of the seed's natural butter. It is flavorful and dissolves easily in liquids, making it an excellent component for a powder composition mix. The powder itself is high in magnesium, antioxidants, and helps lower blood sugar levels.

Pomegranate contains a high level of antioxidants, including soluble polyphenols, tannins and anthocyanins, which all aid in fighting the incidence of free radicals within the body. It also contains a significant amount of good sodium, calcium, vitamin C, niacin, thiamin and riboflavin.

The acai berry is considered one of the strongest superfoods. It has high concentrations of antioxidants, Omega-6 and Omega-9 fatty acids, as well as ideal combinations of essential amino acids, polyphenols and flavonoids. It also contains a plurality of minerals including iron, magnesium potassium, calcium, vitamins B1, B2, B3, C and E, as well as anthocyanins, which have been shown to improve mental function, concentration, memory and clarity, presumably through its beneficial effect on oxygen uptake.

Camu fruit contains powerful phytochemicals such as the amino acids serine, valine and leucine. It is energizing, mood-lifting and strengthens the immune system.

Barley grass is a well-known nutrient rich food. It contains large amounts of protein and 20 amino acids, 12 vitamins and 13 minerals. It is a powerful detoxifier of the liver, blood and gastrointestinal system. It also stimulates metabolism and enzyme production. Like wheatgrass powder, it also contains superoxide dismutase, the P4D1 enzyme and glycosaminoglycans. It may aid in flavoring of the powder composition mix, as some prefer the taste of barley grass to wheatgrass.

Spirulina is derived from a type of algae, and is an excellent source of amino acids, half of it consisting of amino acids by weight. It is also an excellent source of various vitamins, beta-carotene, carotenoids, manganese, copper, iron, zinc, fatty acids and selenium. It aids in protecting the body from oxidative stress and supports the immune system. It helps regulate and maintain a healthy inflammatory response.

Moringa leaf is an extremely nutritious food, containing an extremely high quantity of nutrients and antioxidants. They contain eight essential amino acids, flavonoids, niacin, protein, iron, potassium, thiamin, calcium, riboflavin, lysine, magnesium, manganese and a plurality of vitamins. They contain more vitamin C than oranges, more beta-carotene than carrots, more iron than spinach, more calcium than milk, more potassium than bananas and more fiber than oats.

The following table sets forth the example weight percentage of secondary ingredients for an exemplary formulation of a third nutritional powder composition.

| Ingredients | Weight % (appx.) |
|---|---|
| Pure Pea Protein | 10-16 |
| Milled Flax Seed | 10-16 |
| Maca Powder | 1-5 |
| Cacao Powder | 3-9 |
| Pomegranate Powder | 0-5 |
| Acai Powder | 0-5 |
| Camu Powder | 0-2 |
| Spirulina Powder | 0-5 |
| Moringa Leaf Powder | 1-5 |
| Barley Grass Powder | 1-5 |

The following table sets forth the example weight percentage of main and secondary ingredients for another exemplary formulation of a fourth nutritional powder composition.

| Ingredients | Weight % (appx.) |
|---|---|
| Whey Protein Isolate | 23-29 |
| Milled Chia | 3-9 |
| Hemp Protein | 3-9 |
| Moringa Leaf Powder | 1-5 |
| Wheat Grass Powder | 1-5 |
| Spirulina Powder | 0-5 |
| Goji Powder | 1-5 |
| Pure Pea Protein | 10-16 |
| Milled Flax Seed | 10-16 |
| Maca Powder | 1-5 |
| Cacao Powder | 3-9 |
| Pomegranate Powder | 1-5 |
| Acai Powder | 1-5 |
| Camu Powder | 0-2 |
| Barley Grass Powder | 1-5 |

The following table sets forth a preferred example weight percentage of main and secondary ingredients for the preferred formulation of the nutritional powder composition.

| Ingredients | Weight % (appx.) |
|---|---|
| Whey Protein Isolate | 26.9 |
| Milled Chia | 6.7 |
| Hemp Protein | 6.7 |
| Moringa Leaf Powder | 3.3 |
| Wheat Grass Powder | 3.3 |
| Spirulina Powder | 1.7 |
| Goji Powder | 3.3 |
| Pure Pea Protein | 13.5 |
| Milled Flax Seed | 13.5 |
| Maca Powder | 3.3 |
| Cacao Powder | 6.7 |
| Pomegranate Powder | 3.3 |
| Acai Powder | 3.3 |
| Camu Powder | .8 |
| Barley Grass Powder | 3.3 |

As mentioned above, the nutritional powder composition may be combined with other liquids and foods to make the composition more palatable. For example, the nutritional powder composition may be added to a mixture of fruit and water and blended to create a shake. The following table sets forth a preferred example weight percentage of main ingredients, secondary ingredients, fruit and water for a formulation of the nutritional powder composition as a shake.

| Ingredients | Quantity (Tsp.) (1 Serving) |
|---|---|
| Whey Protein Isolate | 4 |
| Milled Chia | 1 |
| Hemp Protein | 1 |
| Moringa Leaf Powder | .5 |
| Wheat Grass Powder | .5 |
| Spirulina Powder | .25 |
| Goji Powder | .5 |
| Pure Pea Protein | 2 |
| Milled Flax Seed | 2 |
| Maca Powder | .5 |
| Cacao Powder | 1 |
| Pomegranate Powder | .5 |
| Acai Powder | .5 |
| Camu Powder | .125 |
| Barley Grass Powder | .5 |
| Banana | 48 |
| Frozen Berries | 24 |
| Water | 48 |

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed.

What is claimed is:

1. A nutritional powder composition, comprising:
whey protein isolate;
milled chia;
hemp protein;
wheat grass powder; and
goji powder.

2. The nutritional powder composition of claim 1, wherein:
whey protein is present in a range from approximately 15% to 40% of the total volume of the powder;
milled chia is present in a range from approximately 10% to 20% of the total volume of the powder;
hemp protein is present in a range from approximately 1% to 10% of the total volume of the powder;
wheat grass powder is present in a range from approximately 1% to 10% of the total volume of the powder; and
goji powder is present in a range from approximately 1% to 10% of the total volume of the powder

3. The nutritional powder composition of claim 2, wherein:
whey protein is present in a range from approximately 23% to 29% of the total volume of the powder;
milled chia is present in a range from approximately 3-9% of the total volume of the powder;
hemp protein is present in a range from approximately 3% to 9% of the total volume of the powder;
wheat grass powder is present in a range from approximately 1% to 5% of the total volume of the powder; and
goji powder is present in a range from approximately 1% to 5% of the total volume of the powder

4. The nutritional powder composition of claim 1, further comprising at least one additional protein source.

5. The nutritional powder composition of claim 4, wherein the at least one additional protein source is pure pea protein or milled flax seed.

6. The nutritional powder composition of claim 1, further comprising at least one additional fiber source.

7. The nutritional powder composition of claim 6, wherein the additional fiber source is milled flax seed.

8. The nutritional powder composition of claim 1, further comprising at least one additional energy source.

9. The nutritional powder composition of claim 8, wherein the additional energy source is maca powder.

10. The nutritional powder composition of claim 1, further comprising at least one additional omega-3 source.

11. The nutritional powder composition of claim 10, wherein the additional omega-3 source is milled flax seed.

12. The nutritional powder composition of claim 1, further comprising at least one additional antioxidant source.

13. The nutritional powder composition of claim 12, wherein the additional antioxidant source is acai powder or pomegranate powder.

14. The nutritional powder composition of claim 1, further comprising at least one additional superfood.

15. The nutritional powder composition of claim 14, wherein the additional superfood is barley grass powder, moringa leaf powder, or spirulina powder.

16. The nutritional powder composition of claim 1, further comprising at least an additional protein source, an additional fiber source, an additional omega-3 source, an additional energy source, an additional antioxidant source, an additional vitamin C source, an additional antioxidant, and an additional antioxidant.

17. The nutritional composition of claim 1, wherein:
whey protein is present in a range from approximately 23% to 29% of the total volume of the powder;
milled chia is present in a range from approximately 3 to 9% of the total volume of the powder;
hemp protein is present in a range from approximately 3% to 9% of the total volume of the powder;
wheat grass powder is present in a range from approximately 1% to 5% of the total volume of the powder;
goji powder is present in a range from approximately 1% to 5% of the total volume of the powder;
the powder further comprising at least an additional protein source, an additional fiber source, an additional omega 3 source, an additional energy source, an additional antioxidant source, an additional vitamin C source, and an additional superfood.

18. The nutritional composition of claim 18, wherein:
the additional protein source is pure pea protein;
the additional fiber source is milled flax seed;
the additional energy source is maca powder;
the additional antioxidant source is cacao powder, pomegranate powder and acai powder;
the additional vitamin C source is camu powder; and
the additional superfood is barley grass powder, moringa leaf powder, and spirulina powder.

19. The nutritional composition of claim 18, wherein:
pure pea protein is present in a range from approximately 10% to 16% of the total volume of the powder;
milled flax seed is present in a range from approximately 10% to 16% of the total volume of the powder;
maca powder is present in a range from approximately 1% to 5% of the total volume of the powder;
cacao powder is present in a range from approximately 3% to 9% of the total volume of the powder;
pomegranate powder is present in a range from approximately 1% to 5% of the total volume of the powder;
acai powder is present in a range from approximately 1% to 5% of the total volume of the powder;
camu powder is present in a range from approximately 0.01% to 2% of the total volume of the powder;
barley grass powder is present in a range from approximately 1% to 5% of the total volume of the powder;
moringa leaf powder is present in a range from approximately 1% to 5% of the total volume of the powder; and
spirulina powder is present in a range from approximately 0.1 to 5% of the total volume of the powder.

20. The nutritional composition of claim 19, wherein:
whey protein is present in a range from approximately 25% to 27% of the total volume of the powder;
milled chia is present in a range from approximately 5% to 7% of the total volume of the powder;
hemp protein is present in a range from approximately 5% to 7% of the total volume of the powder;
moringa leaf powder is approximately 3% of the total volume of the powder;
wheat grass powder is approximately 3% of the total volume of the powder;
spirulina powder is approximately 2% of the total volume of the powder;
goji powder is approximately 3% of the total volume of the powder;
pure pea protein is present in a range from approximately 12% to 14% of the total volume of the powder;
milled flax seed is present in a range from approximately 12% to 14% of the total volume of the powder;
maca powder is present in a range from approximately 2% to 4% of the total volume of the powder;
cacao powder is present in a range from approximately 5% to 8% of the total volume of the powder;
pomegranate powder is approximately 3% of the total volume of the powder;
acai powder is approximately 3% of the total volume of the powder;
camu powder is approximately 1% of the total volume of the powder; and
barley grass powder is present in a range from about 2% to 5% of the total volume of the powder.
